(19) United States
(12) Patent Application Publication
(10) Pub. No.: US 2025/0142372 A1
(43) Pub. Date: May 1, 2025

(54) SYSTEMS AND METHODS OF ENHANCED ADAPTABILITY IN IMMERSIVE COMMUNICATIONS BASED ON EVENTS AND METRICS FROM REMOTE NETWORK INTERFACES

(71) Applicant: APPLE INC., Cupertino, CA (US)

(72) Inventors: Erik Vladimir Ortega Gonzalez, Cupertino, CA (US); Brajesh K. Dave, Cupertino, CA (US); Chsitopher M. Garrido, Santa Clara, CA (US); Hsien-Po Shiang, San Jose, CA (US); Karthick Santhanam, Campbell, CA (US); Ming Jin, Saratoga, CA (US); Puneet Kumar, San Jose, CA (US); Yang Yu, Redwood City, CA (US)

(21) Appl. No.: 18/926,820

(22) Filed: Oct. 25, 2024

Related U.S. Application Data
(60) Provisional application No. 63/594,706, filed on Oct. 31, 2023.

(51) Int. Cl. H04W 24/04

(52) U.S. Cl. CPC H04W 24/04

(57) ABSTRACT

A method and apparatus of a device that manages a video telephony call is described. In an exemplary embodiment, the device receives a heads-up of a network event from a network service of a device. The device further determines that the network event that is due to a local disruption of a network component of the device. In addition, and in response to the determination, the device adjusts a target delay of the video telephony call.

### RELATED CASES

This application claims the benefit of U.S. Provisional Patent Application No. 63/594,706, filed on Oct. 31, 2023, which application is incorporated herein by reference.

### FIELD OF INVENTION

This invention relates generally to real-time communications and more particularly to enhancing an adaptability for the real-time communications based on events and/or metrics from network interfaces of a device.

### BACKGROUND OF THE INVENTION

Immersive video telephony is technology that is used to communicate audio-video signals between two or more devices. Video telephony can be used over different types of network technologies (e.g., Wi-Fi, Cellular, Bluetooth). However, certain Wi-Fi related events such as roaming scans during a video telephony call cause small outages on the data flow that can last typically under few hundred milliseconds and further can produce media artifacts. These media artifacts can cause dynamic local controls of the video telephony call (e.g., rate control, redundancy control, link duplication, or jitter buffer management) to affect the quality of the video telephony call. In immersive communications latency is a critical factor and keeping it low provides more realistic experience.

### SUMMARY OF THE DESCRIPTION

A method and apparatus of a device that manages a video telephony call is described. In an exemplary embodiment, the device receives a heads-up of a network event from a network service of a device. The device further determines that the network event that is due to a local disruption of a network component of the device. In addition, and in response to the determination, the device adjusts a target delay of the video telephony call.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 is an illustration of one embodiment of a system that performs a video telephony call.

FIG. 2 is an illustration of one embodiment of a plot showing Wi-Fi events interrupting a video telephony stream.

FIG. 3 is an illustration of one embodiment of a plot showing a latency and jitter buffer size over time.

FIG. 4 is an illustration of one embodiment of a system of video telephony.

FIG. 5 is a flow diagram of one embodiment of a process that adjusts a target delay of a video telephony call.

FIG. 6 is a flow diagram of one embodiment of a process that resets a target delay of a video telephony call.

FIG. 7 is an illustration of one embodiment of a plot showing Wi-Fi off-channel periods for a video telephony call.

FIG. 8 is an illustration of one embodiment of notification scheme for a jitter buffer and audio player.

FIG. 9 illustrates one example of a typical computer system, which may be used in conjunction with the embodiments described herein.

FIG. 10 shows an example of a data processing system, which may be used with one embodiment of the present invention.

### DETAILED DESCRIPTION

A method and apparatus of a device that manages a video telephony call is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that manages a video telephony call is described. In one embodiment, video telephony is technology that is used to communicate audio-video signals between two or more devices. Video telephony can be used over different types of network technologies (e.g., Wi-Fi, Cellular, Bluetooth). However, certain Wi-Fi related events such as roaming scans during a video telephony call can cause small outages on the data flow that last typically under few hundred milliseconds and further can produce media artifacts. These media artifacts can cause dynamic local controls of the video telephony call (e.g., rate control, redundancy control, link duplication, or jitter buffer management) affect the quality of the video telephony call. Furthermore, a real-time media communications stack can benefit from having a clearer picture of the quality of local network interface (first hop) in terms of packet loss, bandwidth and delay.

In one embodiment, a network service of a device that is conducting a video telephony call can forward network events and statistics to an audio video conference service. The audio video conference service can receive these events and statistics and determine if the network component (e.g., the Wi-Fi network interface) is having a local disruption of service. For example, and in one embodiment, if the Wi-Fi network interface performs an off-channel scan, which disrupts the Wi-Fi communications temporarily, the audio video conference service can freeze or restrict different local dynamic controls used for the video telephony call (e.g., rate controller, redundancy controller, duplication manager, Coex rate control, and/or jitter buffer management). In addition, if the audio video conference service detects that the Wi-Fi off-channel stop, the audio video conference service can resume the frozen or restricted local dynamic controls.

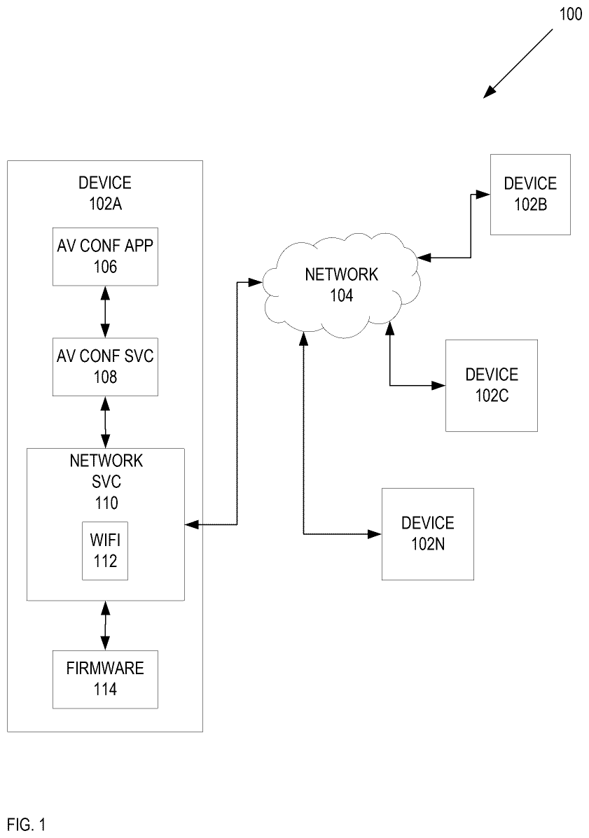

FIG. 1 is an illustration of one embodiment of a system 100 that performs a video telephony call. In FIG. 1, device 102A is coupled through network 104 to devices 102B-D. In one embodiment, device 102A includes an audio video conference application 106 that is used to conduct a video telephony call. In this embodiment, a video telephony call is a simultaneous video and audio communication between two or more devices. At each endpoint of the video telephony call (e.g., one or more of devices 102A-D), a user can receive audio and video communications from one or more other devices and the user can further input audio and video communications into the call. Furthermore, the video telephony relies on a low latency and low jitter in the network 104 to present a quality video telephony for the call. In one embodiment, latency refers to a time lag between successive packets of the video telephony call. In this embodiment, latency can be measured as a time period between successive packets received by one of the endpoints of the video telephony call. A smaller latency allows one of the devices 102A-D to process the audio and/or video packets in time to present a continuous audio-video stream to the user. A larger latency leads to the possibility that the video telephony will be delayed or interrupted. Increased latency can be due to various conditions in the network (e.g., any one of the endpoints in the video telephony call and/or any of the various components in the network 104). In one embodiment, a video telephony call can operate smoothly within a target delay between successive packets. In addition, jitter is the variation in latency as measured in the variability over time of the end-to-end delay across a network. A network with constant delay has no packet jitter.

The devices 102A further includes an audio video service 108 that is used to manage the video telephony call. In one embodiment, the audio video service 108 manages several one or more different local dynamic controls for a video telephony call. In one embodiment, the local dynamic controls can be transmission rate control management, jitter buffer management, redundancy management, and duplication link management. In this embodiment, rate control management is managing the rate control of the audio video transmission from a device 102A-D. If device 102A-D measures a disruption in the audio video stream, the rate control management can decrease (or increase in case of network improving) the rate of transmission for the audio video feed. If the latency and/or jitter is low for the video telephony call, the rate control management can increase the rate of transmission of the audio video stream from the device 102A-D. The increase in transmission is used to send a greater quality of audio and/or video stream. Alternatively, if the latency and/or jitter increases, the rate control management will decrease the audio video stream transmission, such by transmitting lower quality of audio and/or video stream.

Another local dynamic control is jitter buffer management. In one embodiment, the device 102A-D includes a jitter buffer that is used to store the received audio video packets, so that the audio video packets can be processed at continuous rate. In this embodiment, the maximum jitter that can be countered by a jitter buffer can be equal to the buffering delay introduced before starting the play-out of the video telephony call. A larger jitter buffer can handle a greater variation in latency in the audio video stream but can increase a delay in the presentation of the video telephony call. In contrast, a smaller jitter buffer can reduce a delay in the presentation of the video telephony call but reduces the amount of jitter that the device can handle. Thus, the jitter buffer size can change dynamically during the video telephony call.

In addition, during the video telephony call, a section of the bandwidth used for the video telephony can be reserved for redundant packets that can be used in case a primary packet is lost. As packet loss increases, the bitrate dedicated to redundant payload in increased. Alternatively, as packet loss decreases, the redundant payload is not needed as much and the bitrate for the redundant payload is lessened. Another local dynamic control is duplication link management, which is using a secondary link for the video telephony call (e.g., Cellular network) with a primary link is down (e.g., Wi-Fi).

Furthermore, the device 102A includes a network service 110, which controls the network communications of the device 102A (e.g., communication of the data, maintaining of the network interfaces, and/or other network functions). The network service 110 additionally includes one or more interfaces (e.g., Wi-Fi interface 112, and/or other types of network interfaces). The device 102A can use one or more of these interfaces (e.g., Wi-Fi interface 112) to conduct a video telephony call. In addition, the device 102A includes firmware 114 that is used to program the base functions of the device 102A (e.g., network interfaces (e.g., Wi-Fi 112), and other components of device 102A).

In one embodiment, each of the device 102A-D can be any type of device that can conduct a video telephony call (e. g., smartphone, laptop, personal computer, server, tablet, wearable, vehicle component, and/or any type of device that can process instructions of an application). In addition, the network 104 can be any type of network that supports a video telephony call (e.g., Wi-Fi, Cellular, Bluetooth, Ethernet, another type of network, and/or a combination therein). While in one embodiment, fours devices 102A-D and one network 104 are illustrated that are capable of conducting the video telephony call, in alternative embodiments, there can be more or less devices and more than one networks. In addition, two or more of the devices 102A-D can be involved in the video telephony call.

In one embodiment, audiovisual conference service 108 can manage the size of the jitter buffer that is used by the different network interfaces of the device 102A. In this embodiment, the audiovisual conference service 108 can receive a heads-up that a Wi-Fi off channel scan is about to start. In one embodiment, a Wi-Fi interface of the device 102A can receive a request to perform a task that will take the channel offline for a small period of time. In this embodiment, instead of acting immediately, the interface can send a heads up and start later. This delay can be a function of the magnitude of the single outage period. By receiving a heads-up that Wi-Fi off channel scan is about to start, the audiovisual conference service 108 can adjust a target delay to compensate for the Wi-Fi off channel scan. In one embodiment, the Wi-Fi off-channel scan heads-up is time period that is long enough to allow a jitter buffer to grow to a reasonable size to handle the delays caused by a Wi-Fi off-channel scan. As per above, the small network outages due to the Wi-Fi off-channel scanning can produce spikes in the measured jitter of typically few hundred milliseconds. These jitter spikes can result in audio erasures. In one embodiment, increasing the target delay to size that can handle the Wi-Fi off-channel scan can cause the jitter buffer to grow during the time period prior to the Wi-Fi off-channel scan start, so that the jitter buffer is large enough to handle the delay caused by the Wi-Fi off-channel scan. The jitter buffer adjustment, in one embodiment, can be handled by the normal jitter buffer management.

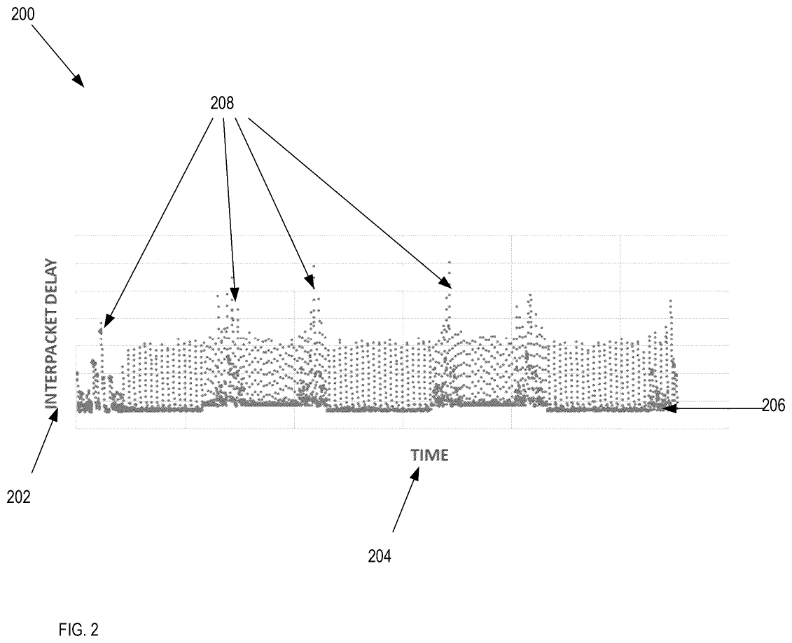

In one embodiment, if a device (e.g., device 102A) uses a Wi-Fi interface for conducting a video telephony call, the Wi-Fi interface can sometimes go off-channel that disrupts the communications. In this embodiment, the Wi-Fi interface performs off-channel scanning that tunes the Wi-Fi radio to another channel to look for available access points (APs) or scans for APs on a channel to which it is not connected (hence “off-channel”). The device scans the off-channel APs looking for a suitable AP to connect to in case it needs to roam from its current ‘on-channel’ AP. FIG. 2 is an illustration of one embodiment of a plot 200 showing Wi-Fi off-channel events interrupting a video telephony stream. In FIG. 2, the plot 200 plots latency of the video telephony packets (illustrated as an interpacket delay in milliseconds (ms) (202)) versus time 204. For most of the time, the latency is below 40 ms (206), which is latency that can be used for a high-quality video telephony call. However, periodically, the Wi-Fi interface will go off-channel as described above. During this time, the Wi-Fi temporarily disrupts the communication of the video telephony (and all other communications) during this time, leading large increases in latency for the video telephony call (208). This can cause the latency to jump to 100 ms, 200 ms, 300 ms, or even higher. In one embodiment, because these off-channel scans occur locally on the device, the network can capture when these off-channel scanning events begin and end.

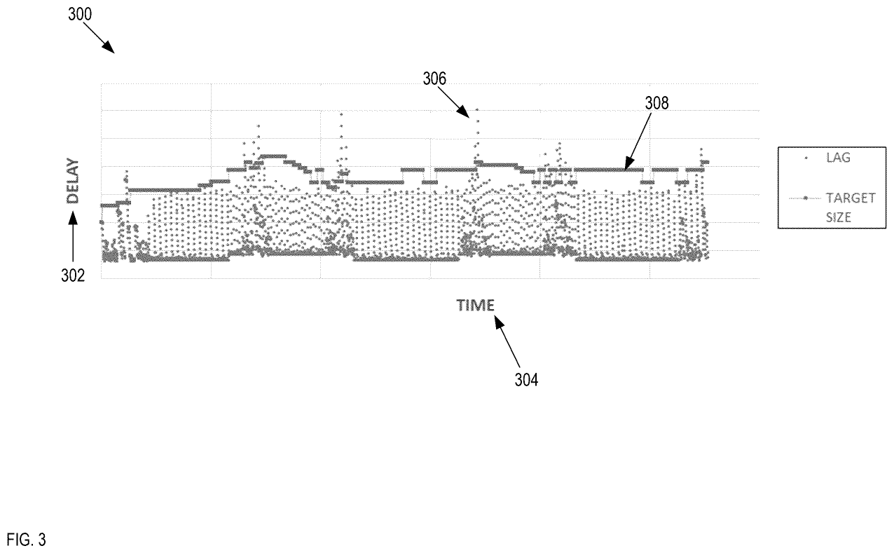

FIG. 3 is an illustration of one embodiment of a plot 300 showing a latency and jitter size over time (304). In FIG. 3, plot 300 shows the jump and drop of the latency (302) jump and return to a baseline over time, which the jump in latency can be due to the Wi-Fi off-channel scan. In one embodiment, the jitter buffer size does not track this jump and drop in latency. Instead, the jitter buffer size (308) stays larger than is needed for when the latency is at or around the baseline.

As described above, Wi-Fi off-channel scans can affect targeted bit rates by causing latencies to spike for a short period of time. In one embodiment, when the latencies spike, the target bitrate rate drops. However, when the latencies drop back down to a baseline, the targeted bitrate rate lags in a recovery to a rate that is more suitable for a baseline latency. Thus, the device local dynamic controls are overreacting to the spike in latency due to the Wi-Fi off-channel scans.

In one embodiment, the network service of the device can detect when the device has entered and stopped the Wi-Fi off-channel scans. In addition, the network service can give a heads-up that going to enter a Wi-Fi off-channel scan. By receiving the heads-up, the device can adjust the target delay to a value more suitable for a Wi-Fi off channel scan. This can allow the delay to grow to over the heads-up timeframe before the Wi-Fi off-channel scan occurs. In one embodiment, the heads-up timeframe is large enough that allows the target delay to grow during the timeframe so that the actual delay grows to that target delay by the time the Wi-Fi off-channel scan happens.

In another embodiment, the device can detect when the Wi-Fi off-channel scan stops. In this embodiment, when the Wi-Fi off-channel scan stops, the target delay is dropped back down to a baseline level that is more suitable for a baseline value. Thus, because the device can detect the start and stop of the device's Wi-Fi off-channel scans and give a heads-up to the start of the devices Wi-Fi off-channel scans, the device can adjust the target delay on the video telephony. In this embodiment, the device's network service can adjust the jitter buffer size in response to the adjustment of the target delay.

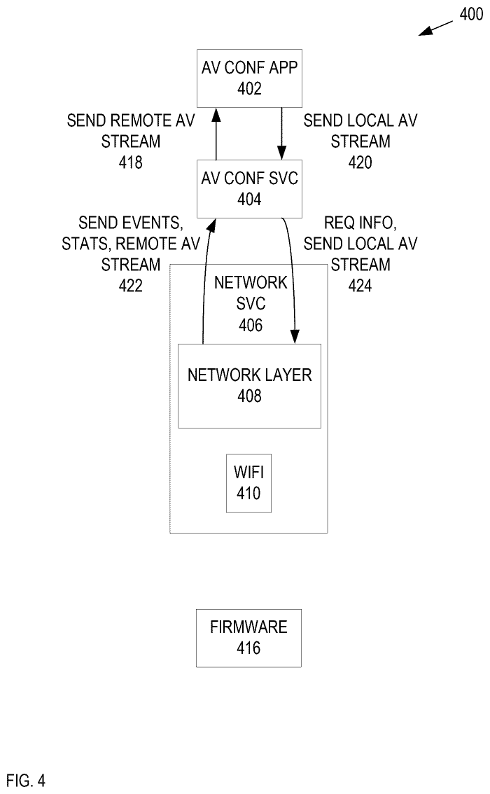

FIG. 4 is an illustration of one embodiment of a system 400 of video telephony. In one embodiment, system 400 is device 102A as described in FIG. 1 above. In FIG. 4, the system 400 includes an audio video conference application 402 the send and receives an audio video stream with the audio video conference service 404. In addition, the audio video conference service 404 requests information (424) from the network layer 408 of the network service. In addition, the audio video conference service 404 sends the local audiovisual stream to the network layer (424). The network layer 408 sends events and/or statistics to the audio video conference service 404. In one embodiment, the events can be the start of and/or the end of the Wi-Fi off-channel scans. In a further embodiment, the statistics can be throughput, delay or queue size, frequency band, quality scores (e.g., delay, loss, overall channel quality, other quality statistics, and/or a combination therein). In addition, the network layer 408 sends the remote audio video stream (422) to the audio video conference service 404. The system 400 further includes the network interfaces (e.g., Wi-Fi 410 and/or other types of network interfaces). These network interfaces can each utilize firmware 412.

In one embodiment, because the audio video conference service 404 receives the statistics and/or events from the network layer 408, the audio video conference service 404 would receive a heads-up that to a Wi-Fi off-channel scan from the local device is about to start. This would notify the audio video conference service 404 that the network disruption is not due a network disruption somewhere else in the network. In this embodiment, the audio video conference service 404 can adjust a target delay during the period of time prior to when the Wi-Fi device is performing an off-channel scan. This allows the audio video conference service 404 to more quickly recover the quality after the off-channel scans finish.

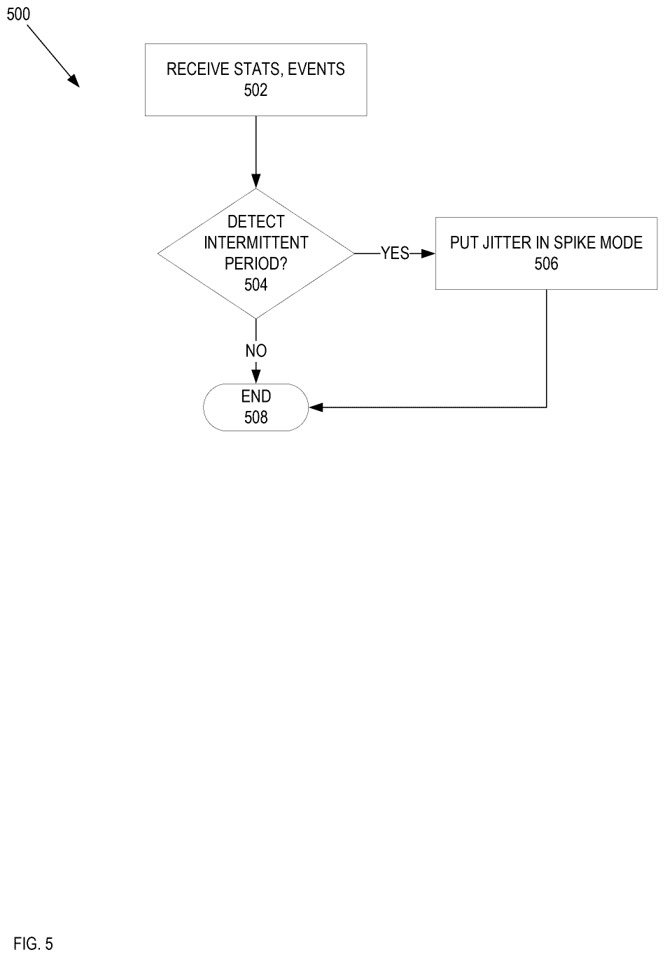

FIG. 5 is a flow diagram of one embodiment of a process 500 that adjusts a target delay of a video telephony call. In one embodiment, process 500 is performed by an audio video conference service that adjusts a target delay, such as audiovisual conference service 108 of FIG. 1 above. In FIG. 5, block 502 begins by receiving statistics and/or events. In one embodiment, process 500 receives the statistics and/or events as described in FIG. 4, block 404 above. At block 504, process 500 determines if a heads-up to a Wi-Fi off-channel scan is detected. In one embodiment, the Wi-Fi off-channel scan heads-up is time period that is long enough to allow a jitter buffer to grow to a reasonable size to handle the delays caused by a Wi-Fi off-channel scan. As per above, the small network outages due to the Wi-Fi off-channel scanning can produce spikes in the measured jitter of typically few hundred milliseconds. These jitter spikes can result in audio erasures. In one embodiment, increasing the target delay to size that can handle the Wi-Fi off-channel scan can cause the jitter buffer to grow during the time period prior to the Wi-Fi off-channel scan start, so that the jitter buffer is large enough to handle the delay caused by the Wi-Fi off-channel scan. The jitter buffer adjustment, in one embodiment, can be handled by the normal jitter buffer management. If, at block 504, process 500 does not detect a Wi-Fi off channel stop, process 500 proceeds to block 502 above.

At block 508, process 500 grows the jitter buffer during the time period prior to the start of the Wi-Fi off-channel scan. Execution proceeds to block 508, where process 500 ends.

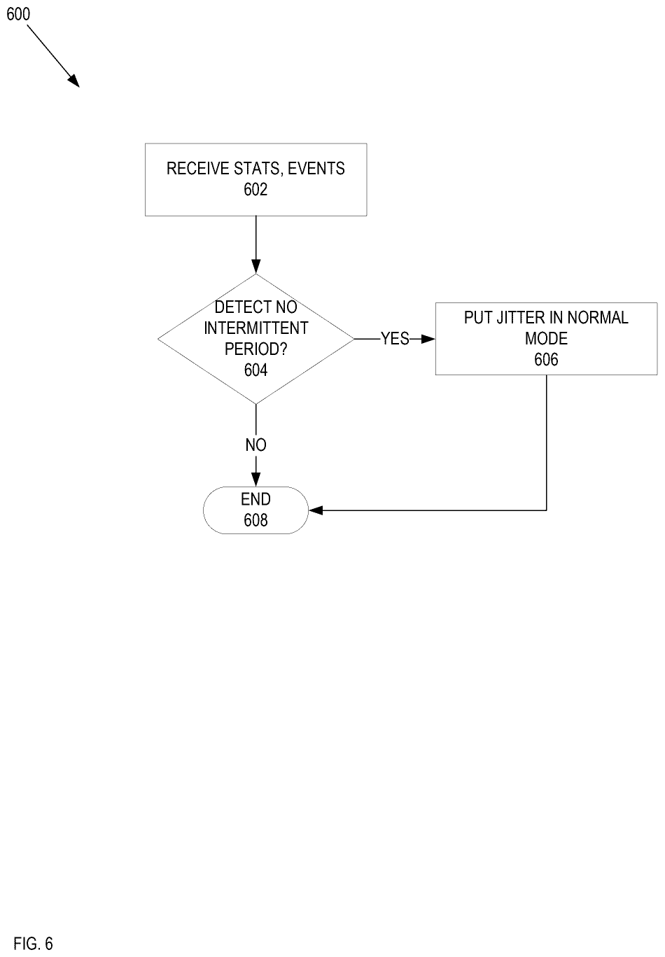

FIG. 6 is a flow diagram of one embodiment of a process that resets a target delay of a video telephony call. In one embodiment, process 600 is performed by an audio video conference service that adjusts a target delay, such as audiovisual conference service 108 of FIG. 1 above. In FIG. 6, block 602 begins by receiving statistics and/or events. In one embodiment, process 600 receives the statistics and/or events as described in FIG. 4, block 408 above. At block 604, process 600 detects the detects a Wi-Fi off channel stop. If process 600 detects a Wi-Fi off channel stop, process 600 puts the resets the target delay at block 606. In one embodiment, process 600 resets the target delay to a value to is more appropriate for a baseline delay. At block 608, process 600 shrinks the jitter buffer to a size that is appropriate to the target delay. In one embodiment, the jitter buffer shrinkage can be handled by the normal jitter buffer management. Execution proceeds to block 608, where process 600 ends. If, at block 604, process 600 does not detect a Wi-Fi off channel stop, process 600 proceeds to block 602 above.

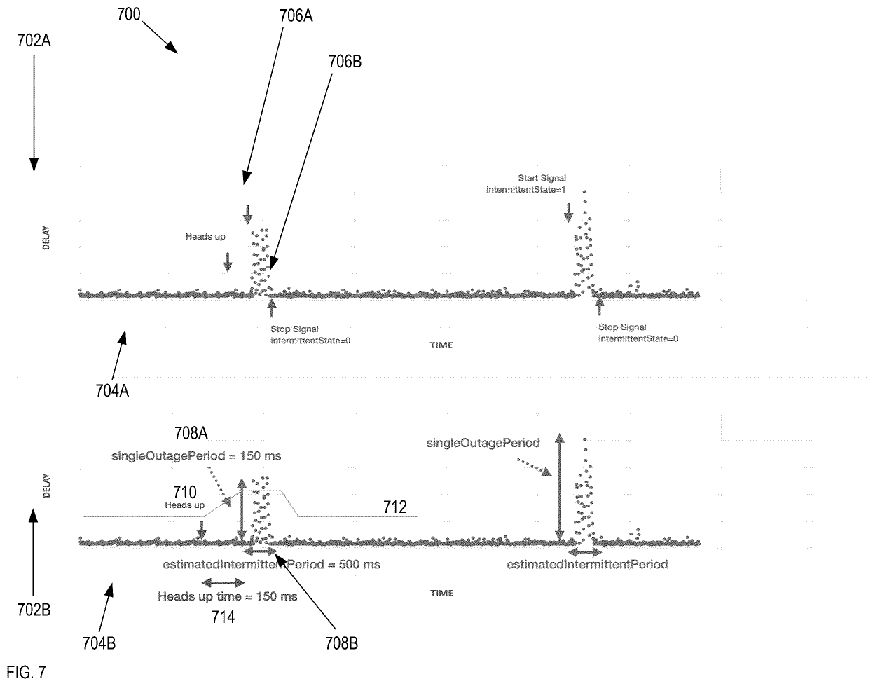

FIG. 7 is an illustration of one embodiment of a plot 700 showing Wi-Fi off-channel periods for a video telephony call. In FIG. 7, plot 700 illustrates a delay (702A-B) versus time (704A-B). In this plot 700, a Wi-Fi off-channel scan starts (706A) that can causes a disruption of a video telephony call as described above. The Wi-Fi off-channel scan lasts until a stop signal 706B for the Wi-Fi off-channel scan is generated. In one embodiment, when an off-channel starts, a Start Signal event is generated, where the event can indicate that an intermittent state has been generated (e.g., intermittentState=1). This starts an intermittent period that can have an estimated period (e.g., 500 ms) and an outage period (e.g., 150 ms).

In one embodiment, a heads-up of a Wi-Fi off-channel start signal 714 is illustrated, where the heads-up time 712 is 150 ms. In one embodiment, this is enough time for a jitter buffer to grow between the heads-up time 714 and the beginning of the Wi-Fi off-channel scan. In this embodiment, the Wi-Fi off-channel scan has a single outage period of 150 ms 708A and an estimated intermittent period 710 of 500 ms.

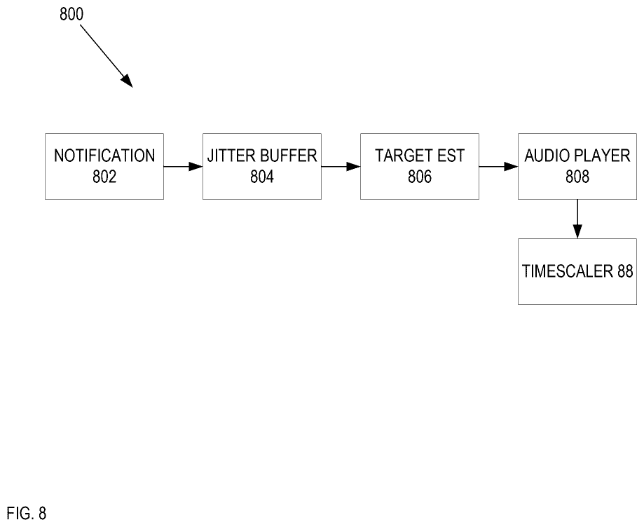

FIG. 8 is an illustration of one embodiment of notification scheme 800 for a jitter buffer and audio player. In FIG. 8, the notification scheme 800 begins by an event being generated (802). In one embodiment, the event can be an event forwarded from network service and can be in relation to a Wi-Fi off-channel scan. For example, and in one embodiment, a network interface event can include information whether there is an intermittent state (e.g., 0—no intermittent state, 1—intermittent state, undefined), an estimated intermittent period (e.g., expressed in ms, which can be 1-5 seconds, or greater or lower), and/or single outage period (e.g., expressed in ms, which can be 40-250 ms, or greater or lower). The event is forwarded to the jitter buffer 804. The jitter buffer 804 processes the event and forwards to the target estimator 806. The target estimator 806 receives the event and generates a new target for the jitter buffer. In one embodiment, for a Wi-Fi off-channel start event, the target for the jitter buffer can be raised to a size that can handle the off-channel period. Audio Player 808 indicates to the time scaler how much to adjust. Timescaler 810 is the component in charge of accelerating or slowing down audio in order to adjust the buffer size as per the desired target queue size.

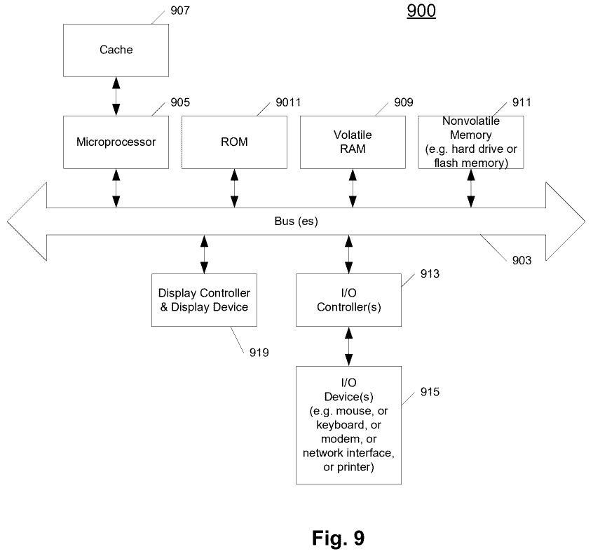

FIG. 9 shows one example of a data processing system 900, which may be used with one embodiment of the present invention. For example, the system 900 may be implemented as a system that includes device 102A as illustrated in FIG. 1 above. Note that while FIG. 9 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 9, the computer system 900, which is a form of a data processing system, includes a bus 903 which is coupled to a microprocessor(s) 905 and a ROM (Read Only Memory) 901 and volatile RAM 909 and a non-volatile memory 911. The microprocessor 905 may include one or more CPU(s), GPU(s), a specialized processor, and/or a combination thereof. The microprocessor 905 may retrieve the instructions from the memories 907, 909, 911 and execute the instructions to perform operations described above. The bus 903 interconnects these various components together and also interconnects these components 905, 907, 909, and 911 to a display controller and display device 919 and to peripheral devices such as input/output (I/O) devices which may be mice, keyboards, modems, network interfaces, printers and other devices which are well known in the art. Typically, the input/output devices 915 are coupled to the system through input/output controllers 913. The volatile RAM (Random Access Memory) 909 is typically implemented as dynamic RAM (DRAM), which requires power continually in order to refresh or maintain the data in the memory.

The mass storage 911 is typically a magnetic hard drive or a magnetic optical drive or an optical drive or a DVD RAM or a flash memory or other types of memory systems, which maintain data (e.g., large amounts of data) even after power is removed from the system. Typically, the mass storage 911 will also be a random access memory although this is not required. While FIG. 9 shows that the mass storage 911 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 903 may include one or more buses connected to each other through various bridges, controllers and/or adapters as is well known in the art.

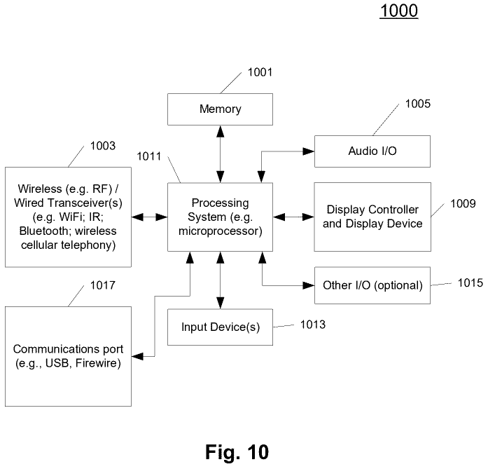

FIG. 10 shows an example of another data processing system 1000 which may be used with one embodiment of the present invention. For example, system 1000 may be implemented as device 102A as shown in FIG. 1 above. The data processing system 1000 shown in FIG. 10 includes a processing system 1011, which may be one or more microprocessors, or which may be a system on a chip integrated circuit, and the system also includes memory 1001 for storing data and programs for execution by the processing system. The system 1000 also includes an audio input/output subsystem 1005, which may include a microphone and a speaker for, for example, playing back music or providing telephone functionality through the speaker and microphone.

A display controller and display device 1009 provide a visual user interface for the user; this digital interface may include a graphical user interface which is similar to that shown on a Macintosh computer when running OS X operating system software, or Apple iPhone when running the iOS operating system, etc. The system 1000 also includes one or more wireless transceivers 1003 to communicate with another data processing system, such as the system 900 of FIG. 9. A wireless transceiver may be a WLAN transceiver, an infrared transceiver, a Bluetooth transceiver, and/or a wireless cellular telephony transceiver. It will be appreciated that additional components, not shown, may also be part of the system 1000 in certain embodiments, and in certain embodiments fewer components than shown in FIG. 10 may also be used in a data processing system. The system 1000 further includes one or more communications ports 1017 to communicate with another data processing system, such as the system 1000 of FIG. 10. The communications port may be a USB port, Firewire port, Bluetooth interface, etc.

The data processing system 1000 also includes one or more input devices 1013, which are provided to allow a user to provide input to the system. These input devices may be a keypad or a keyboard or a touch panel or a multi touch panel. The data processing system 1000 also includes an optional input/output device 1015 which may be a connector for a dock. It will be appreciated that one or more buses, not shown, may be used to interconnect the various components as is well known in the art. The data processing system shown in FIG. 13 may be a handheld computer or a personal digital assistant (PDA), or a cellular telephone with PDA like functionality, or a handheld computer which includes a cellular telephone, or a media player, such as an iPod, or devices which combine aspects or functions of these devices, such as a media player combined with a PDA and a cellular telephone in one device or an embedded device or other consumer electronic devices. In other embodiments, the data processing system 1000 may be a network computer or an embedded processing device within another device, or other types of data processing systems, which have fewer components or perhaps more components than that shown in FIG. 9.

At least certain embodiments of the inventions may be part of a digital media player, such as a portable music and/or video media player, which may include a media processing system to present the media, a storage device to store the media and may further include a radio frequency (RF) transceiver (e.g., an RF transceiver for a cellular telephone) coupled with an antenna system and the media processing system. In certain embodiments, media stored on a remote storage device may be transmitted to the media player through the RF transceiver. The media may be, for example, one or more of music or other audio, still pictures, or motion pictures.

The portable media player may include a media selection device, such as a click wheel input device on an iPod® or iPod Nano® media player from Apple, Inc. of Cupertino, CA, a touch screen input device, pushbutton device, movable pointing input device or other input device. The media selection device may be used to select the media stored on the storage device and/or the remote storage device. The portable media player may, in at least certain embodiments, include a display device which is coupled to the media processing system to display titles or other indicators of media being selected through the input device and being presented, either through a speaker or earphone(s), or on the display device, or on both display device and a speaker or earphone(s). Examples of a portable media player are described in published U.S. Pat. No. 7,345,671 and U.S. published patent number 2004/0224638, both of which are incorporated herein by reference.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMS, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMS, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “detecting,” “determining,” “setting,” “adjusting,” “communicating,” “sending,” “receiving,” “resetting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A non-transitory machine-readable medium having executable instructions to cause one or more processing units to perform a method to manage a video telephony call, the method comprising:
receiving a heads-up of a network event from a network service of a device;
determining that the network event is due to a local disruption of a network component of the device; and
in response to the determination, adjusting a target delay of the video telephony call.

2. The non-transitory machine-readable medium of claim 1, wherein the network component is a Wi-Fi network component.

3. The non-transitory machine-readable medium of claim 1, wherein the event is a Wi-Fi off-channel start event.

4. The non-transitory machine-readable medium of claim 1, detecting the network event.

5. The non-transitory machine-readable medium of claim 4, further comprising:
in response to detecting the network event, setting a jitter buffer into a spike mode.

6. The non-transitory machine-readable medium of claim 1, further comprising:
determining that network event is due to a local resumption of the network component of the device; and
in response to the resumption determination, resetting the target delay of the video telephony call.

7. The non-transitory machine-readable medium of claim 1, wherein the network event is a Wi-Fi off-channel stop.

8. A method comprising:
receiving a heads-up of a network event from a network service of a device;
determining that the network event is due to a local disruption of a network component of the device; and
in response to the determination, adjusting a target delay of the video telephony call.

9. The method of claim 8, wherein the network component is a Wi-Fi network component.

10. The method of claim 8, wherein the event is a Wi-Fi off-channel start event.

11. The method of claim 8, further comprising:
detecting the network event.

12. The method of claim 11, further comprising:
in response to detecting the network event, setting a jitter buffer into a spike mode.

13. The method of claim 8, further comprising:
determining that network event is due to a local resumption of the network component of the device; and
in response to the resumption determination, resetting the target delay of the video telephony call.

14. The method of claim 8, wherein the network event is a Wi-Fi off-channel stop.

15. A method to manage a video telephony call, the method comprising:
receiving a heads-up of a network event from a network service of a device;
determining that the network event is due to a local disruption of a network component of the device, and in response to the determination, adjusting a target delay of the video telephony call.

16. The method of claim 15, wherein the network component is a Wi-Fi network component.

17. The method of claim 15, wherein the event is a Wi-Fi off-channel start event.

18. The method of claim 15, detecting the network event.

19. The method of claim 18, further comprising:
in response to detecting the network event, setting a jitter buffer into a spike mode.

20. A system to manage a video telephony call, the system comprising:
a processor;
a memory coupled to the processor though a bus; and
a process executed from the memory by the processor that causes the processor to receive a heads-up of a network event from a network service of a device, determine that the network event is due to a local disruption of a network component of the device; and in response to the determination, adjust a target delay of the video telephony call.
